(19) United States
(12) Patent Application Publication
(10) Pub. No.: US 2020/0171526 A1
(43) Pub. Date: Jun. 4, 2020

(54) TWO FLUID SPRAY EQUIPMENT

(71) Applicant: TOSHIBA MITSUBISHI-ELECTRIC INDUSTRIAL SYSTEMS CORPORATION, Chuo-ku (JP)

(72) Inventor: Yasushi MORIZONO, Tokyo (JP)

(73) Assignee: TOSHIBA MITSUBISHI-ELECTRIC INDUSTRIAL SYSTEMS CORPORATION, Chuo-ku (JP)

(21) Appl. No.: 16/482,354

(22) PCT Filed: Jul. 27, 2017
(86) PCT No.: PCT/JP2017/027331

§ 371 Date: Jul. 31, 2019

(30) Foreign Application Priority Data
Mar. 27, 2017 (JP) 2017-061003

(51) Int. Cl. B05B 12/08; B05B 7/12

(52) U.S. Cl. CPC B05B 12/082; B05B 7/1254

(57) ABSTRACT

A two fluid spray equipment includes: two fluid nozzles of a plurality of systems; a water supply apparatus for supplying the pressurized water at common pressure; a compressed air supply apparatus for supplying the compressed gas at common pressure; and a plurality of spray control units for controlling spray of the two fluid nozzle of each of the plurality of systems, wherein each of the plurality of spray control units includes a water pressure control unit for performing control to reduce pressure of the pressurized water supplied from the water supply apparatus based on a spray command value without pressurization, and an air pressure control unit for controlling pressure of the compressed gas supplied from the compressed air supply apparatus based on the spray command value.

### FIELD

The present disclosure relates to a two fluid spray equipment.

### BACKGROUND

Generally, a two fluid spray equipment is disclosed in which a compressed gas and a pressurized liquid are supplied to a two fluid nozzle and sprayed.

For example, a two fluid spray equipment is disclosed in which when a pressurized liquid remaining in a pressurized liquid supply system is insufficient, a replenishing liquid from a liquid replenishing system is supplied to the pressurized liquid supply system at higher pressure than that of the pressurized liquid from the pressurized liquid supply system using a compressed gas from a compressed gas supply system, and the pressurized liquid from the pressurized liquid supply system is continuously sprayed at constant supply pressure (see PTL 1).

Also, a two fluid spray equipment is disclosed in which pressure of a compressed gas from a compressed gas supply system can be applied to a pressurized liquid supply system at any level, and pressure of a liquid is controlled to be constant by the compressed gas (see PTL 2).

However, the two fluid spray equipment requires water pressure control with high accuracy at pressure of about 0.5 MPa to control a property of mist to be sprayed. For example, in a fluid spray equipment including a plurality of spray control systems, each spray control system performing water pressure control with high accuracy at pressure of about 0.5 MPa increases manufacturing and operational costs. On the other hand, performing water pressure control with high accuracy of common water to be supplied to the plurality of spray control systems disables control of the property of mist for each spray control system.

### CITATION LIST

### Patent Literature

[PTL 1] JP2014-23976A
[PTL 2] JP2015-102249A

### SUMMARY

An object of the present disclosure is to provide a two fluid spray equipment that controls a property of mist for each of a plurality of spray control systems to reduce manufacturing and operational costs.

A two fluid spray equipment according to an aspect of the present disclosure includes: two fluid nozzles of a plurality of systems for mixing and spraying pressurized water and a compressed gas; pressurized water supply means for supplying the pressurized water at common pressure to the two fluid nozzles of the plurality of systems; compressed gas supply means for supplying the compressed gas at common pressure to the two fluid nozzles of the plurality of systems; and a plurality of spray control means for controlling spray of the two fluid nozzle of each of the plurality of systems, wherein each of the plurality of spray control means includes water pressure control means for performing control to reduce pressure of the pressurized water supplied from the pressurized water supply means based on a spray command value for controlling the spray without pressurization, and gas pressure control means for controlling pressure of the compressed gas supplied from the compressed gas supply means based on the spray command value.

### BRIEF DESCRIPTION OF DRAWINGS

FIG. 1 shows a configuration of a two fluid spray equipment according to a first embodiment of the present disclosure.

FIG. 2 shows a relationship among a spray amount, water pressure, and air pressure used by a calculation processing unit according to the first embodiment.

FIG. 3 shows a configuration of a two fluid spray equipment according to a second embodiment of the present disclosure.

FIG. 4 shows a relationship among a spray amount, water pressure, air pressure, and an air amount used by a calculation processing unit according to the second embodiment.

FIG. 5 shows a configuration of a two fluid spray equipment according to a third embodiment of the present disclosure.

FIG. 6 shows a relationship among a spray amount, water pressure, air pressure, an air amount, and an average particle size used by a calculation processing unit according to the third embodiment.

FIG. 7 shows a configuration of a two fluid spray equipment according to a fourth embodiment of the present disclosure.

FIG. 8 shows a configuration of a two fluid spray equipment according to a fifth embodiment of the present disclosure.

### DESCRIPTION OF EMBODIMENTS

### First Embodiment

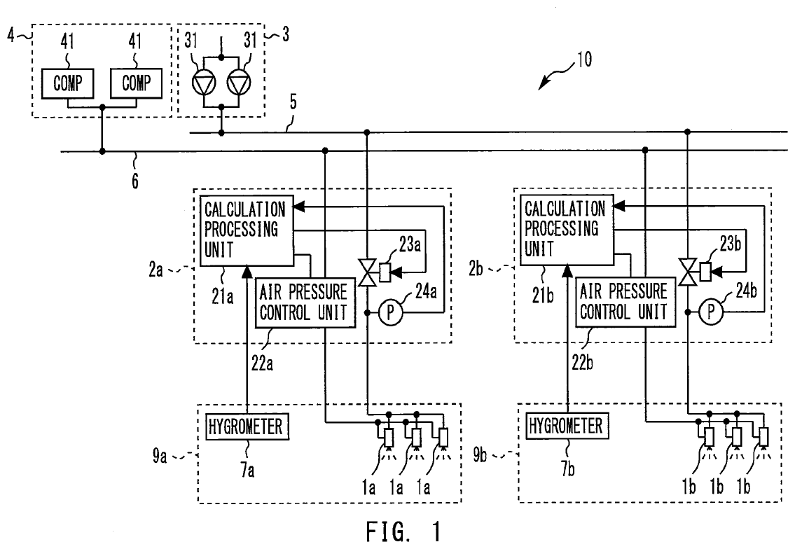

FIG. 1 shows a configuration of a two fluid spray equipment 10 according to a first embodiment of the present disclosure. The same components in the drawings are denoted by the same reference numerals and differences will be mainly described.

The two fluid spray equipment 10 adjusts humidity of two spaces 9a, 9b. The two fluid spray equipment 10 may simultaneously perform temperature adjustment such as cooling or heating as long as it perform humidification. The spaces 9a, 9b may be or may not be partitioned, or may be the same space.

The two fluid spray equipment 10 includes two A and B spray control systems. The two fluid spray equipment 10 may include any number of spray control systems. The two fluid spray equipment 10 includes a plurality of A-system two fluid nozzles 1a, a plurality of B-system two fluid nozzles 1b, an A-system spray control unit 2a, a B-system spray control unit 2b, a water supply apparatus 3, a compressed air supply apparatus 4, a water supply passage 5, an air supply passage 6, and hygrometers 7a, 7b.

The two fluid nozzles 1a, 1b mix a liquid and a gas and spray a misty fluid. In this embodiment, the liquid is water and the gas is air. For example, the water is pure water obtained by refining tap water or the like. The A-system two fluid nozzle 1a is provided in the A-system space 9a. The B-system two fluid nozzle 1b is provided in the B-system space 9b.

The water supply apparatus 3 pressurizes and supplies the water to be sprayed from the two fluid nozzles 1a, 1b. In the water supply apparatus 3, devices such as water supply pumps 31 are duplexed to improve reliability, but do not need to be duplexed.

The compressed air supply apparatus 4 feeds compressed air to the two fluid nozzles 1a, 1b. In the compressed air supply apparatus 4, devices such as compressors 41 are duplexed to improve reliability, but do not need to be duplexed.

The water supply passage 5 is provided so that the water supplied from the water supply apparatus 3 is supplied through the spray control units 2a, 2b to the two fluid nozzles 1a, 1b.

The air supply passage 6 is provided so that the compressed air supplied from the compressed air supply apparatus 4 is supplied through the spray control units 2a, 2b to the two fluid nozzles 1a, 1b.

The A-system hygrometer 7a is provided in the A-system space 9a. The B-system hygrometer 7b is provided in the B-system space 9b. The hygrometers 7a, 7b measure humidities of the spaces 9a, 9b in which the hygrometers 7a, 7b are respectively provided. The hygrometers 7a, 7b transmit the measured humidities to the spray control units 2a, 2b, respectively.

The spray control units 2a, 2b control spray of the two fluid nozzles 1a, 1b based on the humidities measured by the hygrometers 7a, 7b and pressure of the water supplied from the water supply apparatus 3. The A-system spray control unit 2a controls spray of the A-system two fluid nozzle 1a. The B-system spray control unit 2b controls spray of the B-system two fluid nozzle 1b.

The A-system spray control unit 2a includes a calculation processing unit 21a, an air pressure control unit 22a, a valve 23a, and a water pressure measuring device 24a. The B-system spray control unit 2b includes a calculation processing unit 21b, an air pressure control unit 22b, a valve 23b, and a water pressure measuring device 24b. The B-system spray control unit 2b is configured similarly to the A-system spray control unit 2a, and thus the A-system spray control unit 2a will be mainly described below.

The valve 23a is provided midway of the water supply passage 5 through which the water supplied from the water supply apparatus 3 is supplied to the A-system two fluid nozzle 1a. The valve 23a opens/closes the water supply passage 5 or adjusts a flow rate of the water flowing through the water supply passage 5. The valve 23a may be of any type as long as it can open/close the water supply passage 5. For example, the valve 23a is a two-way valve or a regulator. No valve 23a may be provided.

The water pressure measuring device 24a is provided midway of the water supply passage 5 through which the water supplied from the water supply apparatus 3 is supplied to the A-system two fluid nozzle 1a. The water pressure measuring device 24a measures pressure of the water flowing through the water supply passage 5. The water pressure measuring device 24a transmits the measured water pressure to the calculation processing unit 21a.

The calculation processing unit 21a performs calculation processing in the A-system spray control unit 2a. The calculation processing unit 21a calculates pressure of the compressed air to be supplied to the A-system two fluid nozzle 1a based on a command value of a spray amount and the water pressure measured by the water pressure measuring device 24a. The command value of the spray amount is determined based on the humidity measured by the hygrometer 7a. The calculation processing unit 21a generates an air pressure command value for controlling the pressure of the compressed air based on the calculated air pressure. The calculation processing unit 21a outputs the generated air pressure command value to the air pressure control unit 22a.

The air pressure control unit 22a controls the pressure of the compressed air based on the air pressure command value calculated by the calculation processing unit 21a and supplies the air to the A-system two fluid nozzle 1a.

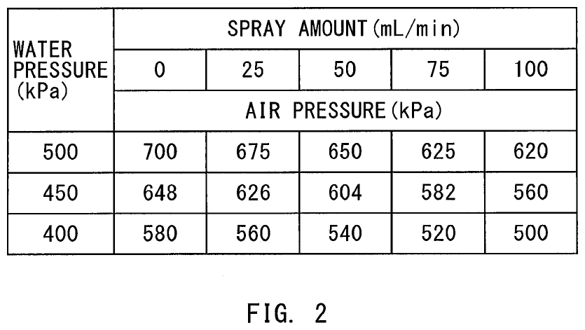

FIG. 2 shows a relationship among a spray amount, water pressure, and air pressure used by the calculation processing unit 21a according to this embodiment.

Here, a rated spray amount (100%) is 100 mL/min, and the command value of the spray amount is 0%, 25%, 50%, 75%, or 100%.

The calculation processing unit 21a stores a table representing the relationship in FIG. 2. For example, when the water pressure measured by the water pressure measuring device 24a is 400 kPa and the command value of the spray amount is 50%, the pressure of the compressed air needs to be 540 kPa. Then, the calculation processing unit 21a sets the air pressure command value to 540 kPa, and thus the compressed air at the pressure of 540 kPa is supplied to the A-system two fluid nozzle 1a. Thus, the spray amount of the A-system two fluid nozzle 1a becomes 50 mL/min.

The water supply apparatus 3 supplies the water at the pressure of 500 kPa, 450 kPa, or 400 kPa in FIG. 2. Thus, if the water pressure measured by the water pressure measuring device 24a is any of these values, the calculation processing unit 21a directly determines the air pressure command value from the stored table.

Next, the case where the water supply pressure of the water supply apparatus 3 varies will be described.

It is assumed that when the command value of the spray amount is 50% (50 mL/min), the measured water pressure is 425 kPa. In this case, the table does not include air pressure at the water pressure of 425 kPa, and thus the calculation processing unit 21a calculates the air pressure command value as described below.

The calculation processing unit 21a obtains, from the table, air pressures when the water pressure is higher than and lower than the measured water pressure for the command value of the spray amount. The water pressure higher than the measured water pressure of 425 kPa by one level is 450 kPa, and the water pressure lower than 425 kPa by one level is 400 kPa. When the spray amount is 50% and the water pressure is 450 kPa, the air pressure is 604 kPa. When the spray amount is 50% and the water pressure is 400 kPa, the air pressure is 540 kPa.

When the measured water pressure is Pm, water pressure higher than Pm is Pwu, water pressure lower than Pm is Pwd, air pressure at the water pressure of Pwu for the command value of the spray amount is Pau, and air pressure at the water pressure of Pwd for the command value of the spray amount is Pad, the air pressure command value is obtained by the following expression:

Air pressure command value=(Pm−Pwd)/(Pwu−Pm)×(Pau−Pad) Expression (1)

From the expression, air pressure command value=(425−400)/(450−425)×(604−540)=572 kPa is obtained.

The calculation processing unit 21a sets the air pressure command value to 572 kPa, and thus the air pressure control unit 22a supplies the compressed air at the pressure of 572 kPa to the A-system two fluid nozzle 1a. Thus, even if the water supply pressure of the water supply apparatus 3 varies, the spray amount of the A-system two fluid nozzle 1a is maintained at 50%.

According to this embodiment, the water pressure applied to the two fluid nozzles 1a, 1b is measured, and the pressure of the compressed air is controlled based on the measured water pressure, thereby allowing the spray amounts of the two fluid nozzles 1a, 1b to be controlled. This allows variations in the water pressure, and thus the water supply apparatus 3 does not need to be able to control the water supply pressure with high accuracy. Therefore, manufacturing costs of the two fluid spray equipment 10 can be reduced.

### Second Embodiment

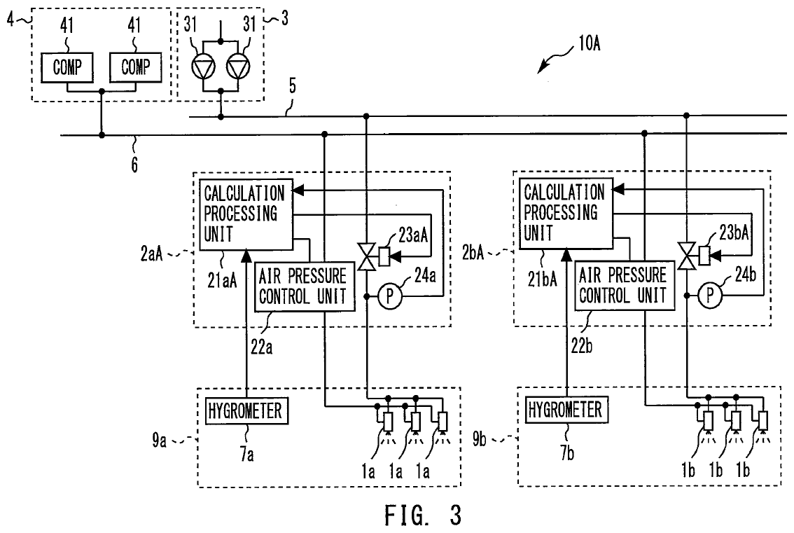

FIG. 3 shows a configuration of a two fluid spray equipment 10A according to a second embodiment of the present disclosure.

The two fluid spray equipment 10A includes spray control units 2aA, 2bA instead of the two spray control units 2a, 2b in the two fluid spray equipment 10 according to the first embodiment in FIG. 1. Other points are similar to those in the two fluid spray equipment 10 according to the first embodiment.

The A-system spray control unit 2aA includes a control valve 23aA instead of the valve 23a and a calculation processing unit 21aA instead of the calculation processing unit 21a in the A-system spray control unit 2a according to the first embodiment. Other points are similar to those in the A-system spray control unit 2a according to the first embodiment.

The B-system spray control unit 2aB includes a control valve 23bA instead of the valve 23b and a calculation processing unit 21bA instead of the calculation processing unit 21b in the B-system spray control unit 2b according to the first embodiment. Other points are similar to those in the B-system spray control unit 2b according to the first embodiment.

The B-system spray control unit 2bA is configured similarly to the A-system spray control unit 2aA, and thus the A-system spray control unit 2aA will be mainly described below.

The control valve 23aA controls water pressure based on a water pressure command value calculated by the calculation processing unit 21aA, and supplies water to the A-system two fluid nozzle 1a.

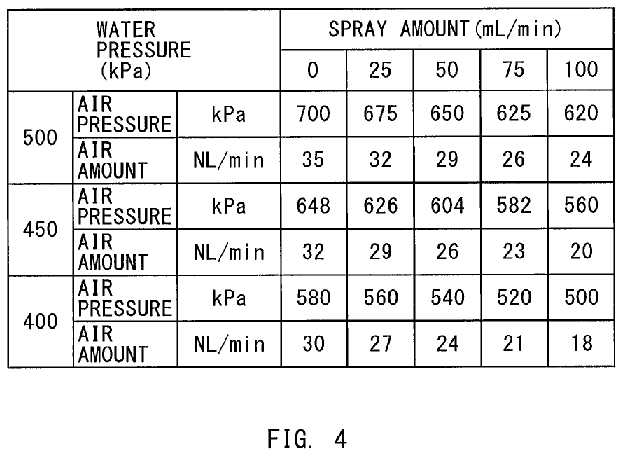

FIG. 4 shows a relationship among a spray amount, water pressure, air pressure, and an air amount used by the calculation processing unit 21aA according to this embodiment. FIG. 4 shows data of the air amount in addition to the relationship in FIG. 2.

The calculation processing unit 21aA stores a table representing the relationship in FIG. 4. The calculation processing unit 21aA determines a water pressure command value and an air pressure command value in two operation modes of normal and energy saving operations. The operation modes may be switched based on a command value of the spray amount, manually, or by other methods. For example, when the command value of the spray amount becomes low such as 0%, the operation mode is switched from the normal operation to the energy saving operation. The operation of the calculation processing unit 21aA in the normal operation is similar to that of the calculation processing unit 21a according to the first embodiment.

Next, the operation of the calculation processing unit 21aA in the energy saving operation will be described.

The case will be described where the equipment is operated in the normal operation at the command value of the spray amount of 0%, the water pressure of 500 kPa, and the air pressure of 700 kPa and the mode is switched from the normal operation to the energy saving operation.

The calculation processing unit 21aA calculates a water pressure command value so as to reduce the water pressure from 500 kPa to 400 kPa. The calculation processing unit 21aA also calculates an air pressure command value corresponding to the water pressure of 400 kPa so as to maintain the command value of the spray amount of 0%. Specifically, the calculation processing unit 21aA sets the air pressure command value to 580 kPa. Thus, the control valve 23aA controls the water pressure to be 400 kPa. The air pressure control unit 22a controls the air pressure to be 580 kPa. When changing the water pressure command value, the calculation processing unit 21aA may determine the water pressure command value also in view of a particle size (for example, an average particle size) of a spray particle.

From the above control, the air pressure is reduced from 700 kPa to 580 kPa, and the air amount is reduced from 35 NL/min to 30 NL/min.

According to this embodiment, in addition to the effect of the first embodiment, the water pressure is controlled to be reduced, thereby allowing the air pressure and the air amount to be reduced without changing the spray amount. Also, the water supply apparatus 3 supplies water at maximum pressure required by all the spray control units 2aA, 2bA, and thus the spray control units 2aA, 2bA require no means for increasing the pressure. Thus, operational and facility costs of the two fluid spray equipment 10A can be reduced.

### Third Embodiment

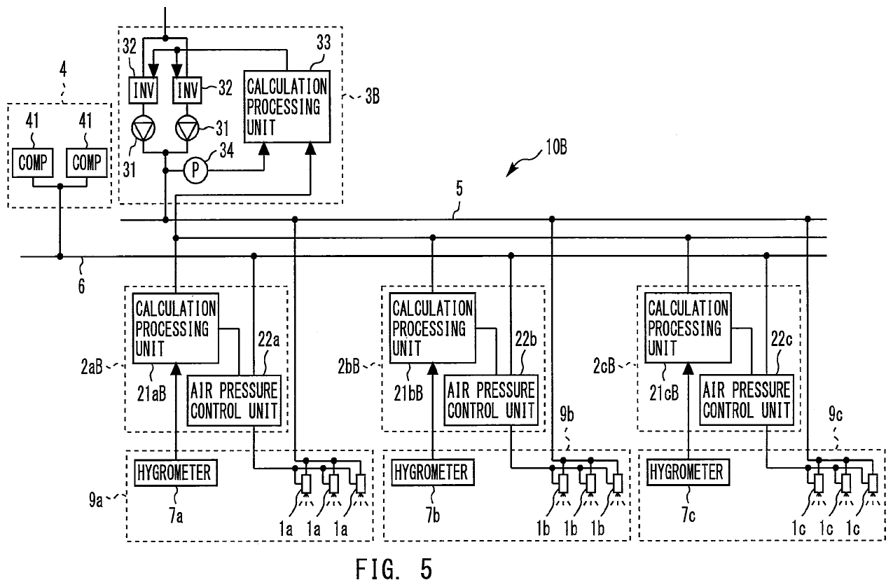

FIG. 5 shows a configuration of a two fluid spray equipment 10B according to a third embodiment of the present disclosure.

The two fluid spray equipment 10B includes C-system spray control added, a water supply apparatus 3B instead of the water supply apparatus 3, spray control units 2aB, 2bB instead of the spray control units 2a, 2b, a C-system spray control unit 2cB, and two fluid nozzles 1c and a hygrometer 7c provided in a C-system space 9c added in the two fluid spray equipment 10 according to the first embodiment in FIG. 1. Other points are similar to those in the two fluid spray equipment 10 according to the first embodiment.

The water supply apparatus 3B includes two water supply pumps 31, two inverters 32, a calculation processing unit 33, and a water pressure measuring device 34. In the water supply apparatus 3B, devices are duplexed but do not need to be duplexed as in the first embodiment.

The inverters 32 are connected to the water supply pumps 31, respectively. The inverter 32 controls water pressure output from the water supply pump 31 with high accuracy. The inverter 32 controls the water pressure of the water supply pump 31 based on a control command value output from the calculation processing unit 33.

The water pressure measuring device 34 measures water pressure output from the water supply apparatus 3B (two water supply pumps 31). The water pressure measuring device 34 outputs the measured water pressure to the calculation processing unit 33.

The calculation processing unit 33 receives spray information for the spray control units 2aB to 2cB to control spray. The spray information relates to a property of mist sprayed from the two fluid nozzles 1a to 1c of the respective systems. For example, the spray information includes a spray amount or a particle size (for example, an average particle size) of a spray particle. The calculation processing unit 33 determines a water pressure command value based on the spray information. The calculation processing unit 33 outputs the control command value to the inverter 32 so that the water pressure output from the water supply apparatus 3B becomes the determined water pressure command value. The calculation processing unit 33 transmits the water pressure measured by the water pressure measuring device 34 to the spray control units 2aB to 2cB.

The A-system spray control unit 2aB includes a calculation processing unit 21aB instead of the calculation processing unit 21a and eliminates the valve 23a and the water pressure measuring device 24a in the A-system spray control unit 2a according to the first embodiment. Thus, the water supplied from the water supply apparatus 3B is supplied as it is to the A-system two fluid nozzle 1a. Other points are similar to those in the A-system spray control unit 2a according to the first embodiment.

The B-system spray control unit 2bB and the C-system spray control unit 2cB are configured similarly to the A-system spray control unit 2aB, and thus the A-system spray control unit 2aB will be mainly described below.

The calculation processing unit 21aB generates spray information for controlling spray of the A-system two fluid nozzle 1a based on humidity measured by the hygrometer 7a. The spray information may be determined by any method similarly to the command value of the spray amount in the first embodiment. The calculation processing unit 21aB outputs the generated spray information to the calculation processing unit 33 of the water supply apparatus 3B. The calculation processing unit 21aB generates an air pressure command value based on the generated spray information and outputs the air pressure command value to the air pressure control unit 22a.

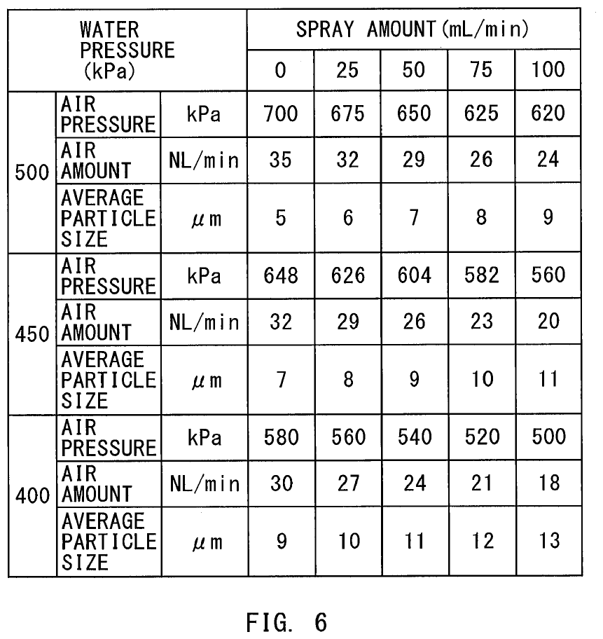

FIG. 6 shows a relationship among a spray amount, water pressure, air pressure, an air amount, and an average particle size used by the calculation processing unit 33 according to this embodiment. FIG. 6 shows data of the average particle size in addition to the relationship in FIG. 4.

The A-system spray control unit 2aB controls the spray amount to 25% (25 mL/min), the B-system spray control unit 2bB controls the spray amount to 50%, the C-system spray control unit 2cB controls the spray amount to 75%.

An evaporation time of mist varies according to a particle size of the mist, and becomes shorter with decreasing particle size. Here, the average particle size of 10 μm or less is required in each system.

With reference to FIG. 6, to obtain the average particle size of 10 μm or less, water pressure of 400 kPa or more is required for the spray amount of 25%, water pressure of 450 kPa is required for the spray amount of 50%, and water pressure of 450 kPa or more is required for the spray amount of 75%.

Thus, at the water pressure of 450 kPa, the spray amount may be set to any of 25%, 50%, and 75% with the average particle size of 10 μm or less. Then, the calculation processing unit 33 determines the water pressure command value so that the water supply apparatus 3B supplies water at the pressure of 450 kPa.

In this embodiment, the calculation processing unit 33 of the water supply apparatus 3B is described to receive the spray information from the spray control units 2aB to 2cB. However, the calculation processing unit 33 may receive water pressures requested by the spray control units 2aB to 2cB as information instead of the spray information. In this case, the spray control units 2aB to 2cB determine required water pressures according to the contents of the spray control (the spray amount or average particle size, or the like), and transmits the water pressures to the calculation processing unit 33. The calculation processing unit 33 may determine, as the water pressure command value, the highest water pressure among the water pressures requested by the spray control units 2aB to 2cB.

In this embodiment, the apparatus that controls the water pressure with high accuracy is provided as the water supply apparatus 3B that supplies water to each spray control system, and thus the accuracy of pressure of the water to be supplied to the two fluid nozzles 1a to 1c can be increased without control of the water pressure by each spray control system.

Also, varying the supply pressure of the water supply apparatus 3B according to the current situation of each spray control system can minimize the water pressure. Thus, the operation at the low water pressure can reduce the air amount of the released compressed air, and reduce total consumption of air.

For example, in FIG. 6, for the spray amount of 100%, the water pressure of 500 kPa or more is required to obtain the average particle size of 10 μm or less. Thus, if the supply pressure of the water supply apparatus 3B is fixed, the supply pressure needs to be 500 kPa or more. On the other hand, in this embodiment, the water can be supplied at the pressure of 450 kPa according to the current situation as described above.

A command value of the supply pressure of the water supply apparatus 3B may be determined by any method. For example, the command value of the supply pressure may be determined by any of information on water in the air such as absolute humidity, relative humidity, or a dew point of outside air. The command value of the supply pressure may be determined by time, date, or season. Further, the command value of the supply pressure may be preset, externally input, or a target output rate of the command value of the supply pressure may be determined in each system. The command value of the supply pressure may be determined based on a combination of these elements.

### Fourth Embodiment

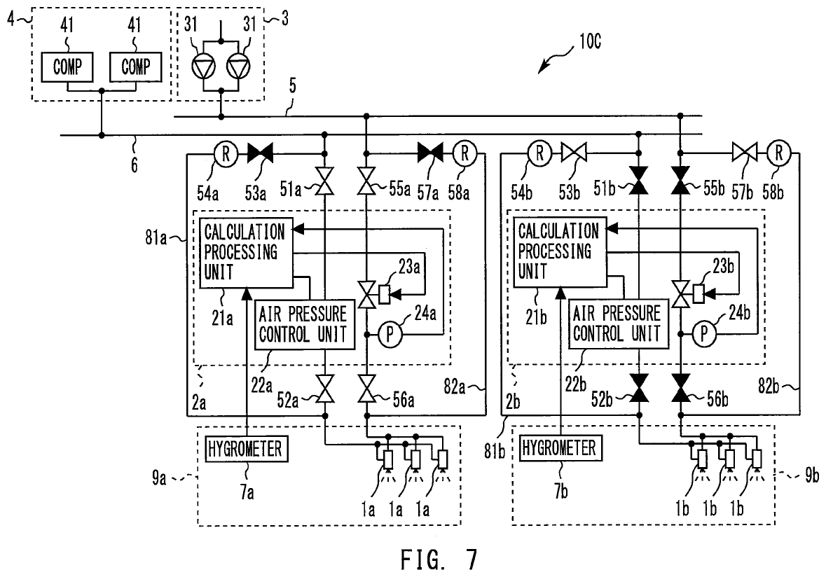

FIG. 7 shows a configuration of a two fluid spray equipment 10C according to a fourth embodiment of the present disclosure.

The two fluid spray equipment 10C includes bypass circuits 81a, 81b of the air supply passage 6 which bypass the spray control units 2a, 2b, and bypass circuits 82a, 82b of the water supply passage 5 which bypass the spray control units 2a, 2b added to the two fluid spray equipment 10 according to the first embodiment in FIG. 1. Other points are similar to those in the two fluid spray equipment 10 according to the first embodiment.

The bypass circuit 81a is an air supply passage that bypasses the A-system spray control unit 2a. The bypass circuit 81a includes three valves 51a, 52a, 53a and a regulator 54a. The bypass circuit 81b is an air supply passage that bypasses the B-system spray control unit 2b. The bypass circuit 81b includes three valves 51b, 52b, 53b and a regulator 54b.

The bypass circuit 82a is a water supply passage that bypasses the A-system spray control unit 2a. The bypass circuit 82a includes three valves 55a, 56a, 57a and a regulator 58a. The bypass circuit 82b is a water supply passage that bypasses the B-system spray control unit 2b. The bypass circuit 82b includes three valves 55b, 56b, 57b and a regulator 58b.

The B-system bypass circuits 81b, 82b are configured similarly to the A-system bypass circuits 81a, 82a, and thus the A-system bypass circuits 81a, 82a will be mainly described.

In FIG. 7, the A-system is not using the bypass circuits 81a, 82a (normal time), and the B-system is using the bypass circuits 81b, 82b.

The case of using the A-system bypass circuits 81a, 82a due to inspection or failure of the A-system spray control unit 2a will be described.

In the normal time, the four valves 51a, 52a, 55a, 56a are opened and the two valves 53a, 57a are closed.

When using the A-system bypass circuit 81a, the two valves 51a, 52a are closed to stop supply of compressed air from the compressed air supply apparatus 4 to the A-system spray control unit 2a. If the valve 53a is opened in this state, the compressed air bypasses the A-system spray control unit 2a and is supplied from the compressed air supply apparatus 4 to the two fluid nozzle 1a. The pressure of the compressed air is adjusted by the regulator 54a.

When using the A-system bypass circuit 82a, the two valves 55a, 56a are closed to stop supply of water from the water supply apparatus 3 to the A-system spray control unit 2a. If the valve 57a is opened in this state, the water bypasses the A-system spray control unit 2a and is supplied from the water supply apparatus 3 to the two fluid nozzle 1a. The water pressure is adjusted by the regulator 58a.

In this embodiment, the configuration is described in which the bypass circuits 81a, 81b, 82a, 82b are applied to the two fluid spray equipment 10 according to the first embodiment, but the bypass circuit may be applied to the second or third embodiment as in this embodiment. In the third embodiment, the bypass circuit may be applied to the water supply apparatus 3B.

According to this embodiment, in addition to the effect of the first embodiment, the bypass circuits 81a, 81b, 82a, 82b are provided to allow manual spray control even when the spray control units 2a, 2b cannot be used due to inspection or failure.

### Fifth Embodiment

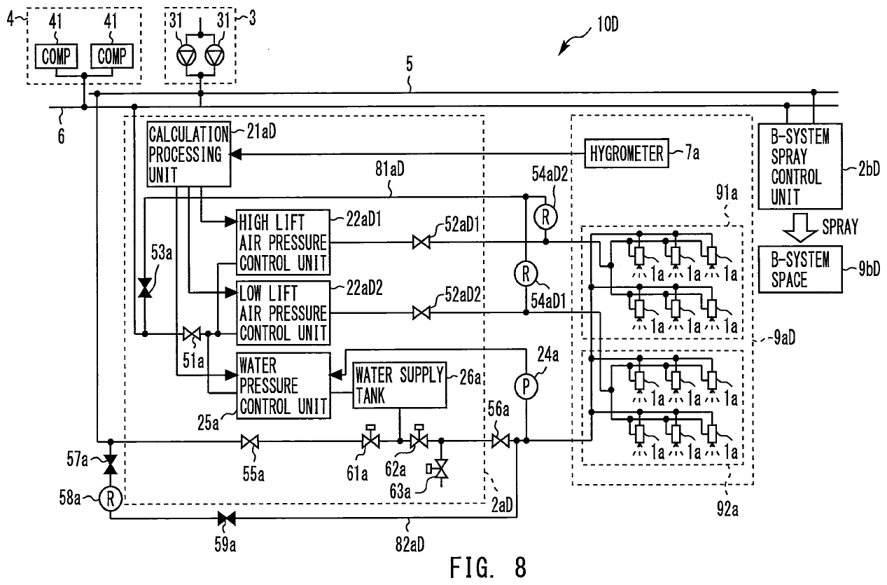

FIG. 8 shows a configuration of a two fluid spray equipment 10D according to a fifth embodiment of the present disclosure.

The two fluid spray equipment 10D includes spray control units 2aD, 2bD instead of the spray control units 2a, 2b, and spaces 9aD, 9bD instead of the spaces 9a, 9b in the two fluid spray equipment 10 according to the first embodiment in FIG. 1. The A-system includes bypass circuits 81aD, 82aD for manual spray control as in the fourth embodiment, but does not need to include the bypass circuits 81aD, 82aD. Other points are similar to those in the two fluid spray equipment 10 according to the first embodiment.

The A-system space 9aD is divided into a high lift space 91a in which the two fluid nozzle 1a is provided in a high lift position and a low lift space 92a in which the two fluid nozzle 1a is provided in a low lift position. Also in this embodiment, all the two fluid nozzles 1a may be provided in the same space and controlled in the same manner as in the other embodiments. The B-system space 9bD is similar to the A-system space 9aD.

The A-system spray control unit 2aD includes a calculation processing unit 21aD, a high lift air pressure control unit 22aD1, a low lift air pressure control unit 22aD2, a water pressure measuring device 24a, a water pressure control unit 25a, a water supply tank 26a, and eight valves 51a, 52aD1, 52aD2, 55a, 56a, 61a, 62a, 63a. The valves 51a, 52aD1, 52aD2, 55a, 56a are manual valves manually operated. The valves 61a, 62a, 63a are electric valves automatically controlled. For example, openings of the valves 61a, 62a, 63a are controlled by command values calculated by the calculation processing unit 21aD. The B-system spray control unit 2bD is configured similarly to the A-system spray control unit 2aD, and thus the A-system spray control unit 2aD will be mainly described below.

The calculation processing unit 21aD is similar to the calculation processing unit 21a according to the first embodiment, and differences will be mainly described here.

The calculation processing unit 21aD calculates pressures of compressed air and water to be supplied to the A-system two fluid nozzle 1a based on a spray command value. The spray command value is determined based on humidity measured by the hygrometer 7a. The spray command value includes a command value of a spray amount, and may further include a command value of an average particle size of a spray particle. For example, the calculation processing unit 21aD may adopt any of the spray controls in the embodiments described above to calculate the spray command value, or use any of the relationships in FIGS. 2, 4 and 6 to calculate the spray command value.

The calculation processing unit 21aD generates a high lift air pressure command value and a low lift air pressure command value for controlling pressure of the compressed air based on the calculated air pressure. The high lift air pressure command value is lower than the low lift air pressure command value in view of a difference of elevation between the A-system two fluid nozzles 1a provided in the two spaces 91a, 92a. The calculation processing unit 21aD outputs the generated high lift air pressure command value to the high lift air pressure control unit 22aD1. The calculation processing unit 21aD outputs the generated low lift air pressure command value to the low lift air pressure control unit 22aD2. The calculation processing unit 21aD generates a water pressure command value for controlling water pressure based on the calculated water pressure. The calculation processing unit 21aD outputs the generated water pressure command value to the water pressure control unit 25a. The calculation processing unit 21aD may receive the water pressure measured by the water pressure measuring device 24a and use the measured water pressure to calculate the water pressure command value.

The high lift air pressure control unit 22aD1 controls the pressure of the compressed air based on the high lift air pressure command value calculated by the calculation processing unit 21aD, and supplies the compressed air to the A-system two fluid nozzle 1a in the high lift space 91a. The low lift air pressure control unit 22aD2 controls the pressure of the compressed air based on the low lift air pressure command value calculated by the calculation processing unit 21aD, and supplies the compressed air to the A-system two fluid nozzle 1a in the low lift space 92a. The air pressure control units 22aD1, 22aD2 are, for example, electro-pneumatic regulators (automatic regulators).

The water supply tank 26a temporarily stores water to control the water pressure. To the water supply tank 26a, water is supplied from the water supply apparatus 3 through the valve 55a and the valve 61a in order. By the valve 61a, an appropriate amount of water is automatically supplied to the water supply tank 26a. The water stored in the water supply tank 26a is controlled in pressure. The water controlled in pressure is supplied from the water supply tank 26a through the valve 62a and the valve 56a in order to the all the A-system two fluid nozzles 1a. By the valve 62a, an appropriate amount of water is automatically supplied to the A-system two fluid nozzle 1a. The water in the water supply tank 26a is discharged through the valve 62a and the valve 63a in order. An amount of discharged water is automatically adjusted by the valve 63a.

The water pressure measuring device 24a measures the pressure of the water to be supplied to the A-system two fluid nozzle 1a. The water pressure measuring device 24a transmits the measured water pressure to the water pressure control unit 25a.

The water pressure control unit 25a performs control to reduce the pressure of the water stored in the water supply tank 26a using the pressure of the compressed air supplied from the compressed air supply apparatus 4, so that the water pressure measured by the water pressure measuring device 24a conforms to the water pressure command value calculated by the calculation processing unit 21aD. Here, the pressure of the water supplied from the water supply apparatus 3 is controlled to be always higher than the water pressure command value calculated by the calculation processing unit 21aD. The water pressure control unit 25a is, for example, an electro-pneumatic regulator (automatic regulator). The water pressure control unit 25a only performs control to reduce the water pressure, and does not need to have a pressurizing function. The water pressure control unit 25a may perform control only with the water pressure command value without using the water pressure measuring device 24a if it can perform control so that the water pressure conforms to the water pressure command value.

Next, the bypass circuits 81aD, 82aD will be described. The bypass circuits 81aD, 82aD are similar to the bypass circuits 81a, 82a according to the fourth embodiment, and thus differences will be mainly described here.

The bypass circuit 81aD is an air supply passage that bypasses the A-system spray control unit 2aD. The bypass circuit 81aD includes a valve 53a, a high lift regulator 54aD1, and a low lift regulator 54aD2.

The bypass circuit 82aD is a water supply passage that bypasses the A-system spray control unit 2aD. The bypass circuit 82aD includes two valves 57a, 59a and a regulator 58a.

In FIG. 8, the A-system bypass circuits 81aD, 82aD are not used (normal time). In the normal time, the five valves 51a, 52aD1, 52aD2, 55a, 56a are opened and the three valves 53a, 57a, 59a are closed.

When using the A-system bypass circuit 81aD, the three valves 51a, 52aD1, 52aD2 are closed to stop supply of compressed air from the compressed air supply apparatus 4 through the A-system spray control unit 2aD to the two fluid nozzle 1a. If the valve 53a is opened in this state, the compressed air bypasses the A-system spray control unit 2aD and is supplied from the compressed air supply apparatus 4 through the regulators 54aD1, 54aD2 to the two fluid nozzle 1a. The pressure of the compressed air to be supplied to the high lift space 91a is adjusted by the regulator 54aD1. The pressure of the compressed air to be supplied to the low lift space 92a is adjusted by the regulator 54aD2.

When using the A-system bypass circuit 82aD, the two valves 55a, 56a are closed to stop supply of water from the water supply apparatus 3 through the A-system spray control unit 2aD to the two fluid nozzle 1a. If the two valves 57a, 59a are opened in this state, the water bypasses the A-system spray control unit 2aD and is supplied from the water supply apparatus 3 through the regulator 58a to the two fluid nozzle 1a. The water pressure is adjusted by the regulator 58a.

According to this embodiment, the water pressure control unit 25a using the automatic regulator or the like with high accuracy of pressure rather than an electric valve or the like controls the water pressure, thereby allowing control with high reliability. Also, the water pressure control unit 25a only performs control to reduce the pressure, thereby allowing a pressurizing function to be omitted and providing an inexpensive configuration.

For example, if the electric valve is used to control water pressure, the number of times of operation of the electric valve may be increased (for example, hundreds of thousands of times) to accommodate variations in pressure of water to be supplied, accommodate control errors, or improve accuracy. This also requires measures for operating life of the electric valve. On the other hand, using the automatic regulator or the like as in this embodiment does not cause such a problem.

The spray control units 2aD, 2bD can control the water pressure and the air pressure with high accuracy. Thus, even if pressure control of one of water and air cannot be performed due to inspection or failure, pressure control of the other can compensate therefor. Thus, even with one pressure control only, the spray control can be continued. For example, in the spray control, the air pressure may be controlled in proportion to the spray command value at the fixed water pressure, or the water pressure may be controlled in proportion to the spray command value at the fixed air pressure.

The bypass circuits 81aD, 82aD are provided to allow manual spray control as backup.

In this embodiment, the pressure of the compressed air to be supplied to the high lift two fluid nozzle 1a is different from that to be supplied to the low lift two fluid nozzle 1a, but the pressure of the water to be supplied may be different instead. In this case, the two air pressure control units 22aD1, 22aD2 are integrated, and the water pressure control unit 25a is separated into a high lift water pressure control unit and a low lift water pressure control unit, thereby allowing spray of the two fluid nozzle 1a to be controlled as in this embodiment.

In this embodiment, the spray control units 2aD, 2bD may be multiplexed. This can improve reliability of the system.

In this embodiment, the water pressure measured by the water pressure measuring device 24a is used only for the control of the water pressure by the water pressure control unit 25a, but may be used for the control of the air pressure by the air pressure control units 22aD1, 22aD2 as in the other embodiments. For example, control may be performed so that the air pressure is corrected according to actual water pressure.

The present disclosure is not limited to the above described embodiments, but may be embodied with modified components without departing from the gist of the present disclosure. The plurality of components disclosed in the above described embodiments may be combined in a suitable manner to achieve various disclosures. For example, some components may be eliminated from all the components disclosed in the embodiments. Further, the components in the different embodiments may be combined in a suitable manner.

1. A two fluid spray equipment comprising:
two fluid nozzles of a plurality of systems for mixing and spraying pressurized water and a compressed gas;
pressurized water supply means for supplying the pressurized water at common pressure to the two fluid nozzles of the plurality of systems;
compressed gas supply means for supplying the compressed gas at common pressure to the two fluid nozzles of the plurality of systems; and
a plurality of spray control means for controlling spray of the two fluid nozzle of each of the plurality of systems,
wherein each of the plurality of spray control means includes
water pressure control means for performing control to reduce pressure of the pressurized water supplied from the pressurized water supply means based on a spray command value for controlling the spray without pressurization, and
gas pressure control means for controlling pressure of the compressed gas supplied from the compressed gas supply means based on the spray command value.

2. The two fluid spray equipment according to claim 1, wherein if one of control of water pressure by the water pressure control means and control of pressure by the gas pressure control means cannot be performed, one pressure is fixed and the other pressure is controlled based on the spray command value.

3. The two fluid spray equipment according to claim 1, comprising:
compressed gas supply bypass means for bypassing at least one of the plurality of spray control means and supplying the compressed gas to the two fluid nozzle to be controlled by the bypassed spray control means; and
gas pressure adjustment means for adjusting pressure of the compressed gas supplied from the compressed gas supply bypass means.

4. The two fluid spray equipment according to claim 1, comprising:
pressurized water supply bypass means for bypassing at least one of the plurality of spray control means and supplying the pressurized water to the two fluid nozzle to be controlled by the bypassed spray control means; and
water pressure adjustment means for adjusting pressure of the pressurized water supplied from the pressurized water supply bypass means.
